(19) United States
(12) Patent Application Publication
(10) Pub. No.: US 2010/0003158 A1
(43) Pub. Date: Jan. 7, 2010

(54) VIBRATORY POWDER CONSOLIDATION

(75) Inventors: Teiichi Ando, Belmont, MA (US); Ibrahim E. Gunduz, Cambridge, MA (US); Peter Y. Wong, Brighton, MA (US); Charalabos C. Doumanidis, Nicosia (CY)

Correspondence Address: WEINGARTEN, SCHURGIN, GAGNEBIN & LEBOVICI LLP, TEN POST OFFICE SQUARE, BOSTON, MA, 02109, US

(73) Assignees: NORTHEASTERN UNIVERSITY, Boston, MA (US); TUFTS UNIVERSITY, Medford, MA (US)

(21) Appl. No.: 12/525,226

(22) PCT Filed: Jan. 30, 2008
(86) PCT No.: PCT/US08/01259

§ 371 Date: Jul. 30, 2009

Related U.S. Application Data
(60) Provisional application No. 60/921,576, filed on Jan. 30, 2007.

(51) Int. Cl. B22F 3/093; B06B 1/00

(52) U.S. Cl. 419/66; 264/443

(57) ABSTRACT

A vibratory powder consolidation process is provided in which a powder material is subjected to vibratory energy while under static compressive loading. The process provides rapid, full-density powder consolidation with minimum or no structural degradation.

### CROSS REFERENCE TO RELATED APPLICATIONS

This application claims the benefit under 35 U.S.C. § 119(e) of U.S. Provisional Application No. 60/921,576, filed Jan. 30, 2007, the disclosure of which is incorporated by reference herein.

### STATEMENT REGARDING FEDERALLY SPONSORED RESEARCH OR DEVELOPMENT

This invention was made under National Science Foundation Grant No. DMI0423228. The Government may have certain rights in this invention.

### BACKGROUND OF THE INVENTION

Powder metallurgy (P/M) is used in the manufacture of many products, ranging from tungsten light bulb filaments to aircraft and automotive parts. P/M also permits processing of materials that are otherwise difficult to process and provides a key approach to the development of advanced materials. P/M parts formed by mass-production, however, normally have residual porosity, originating from the particle interstices in the powder compact, which limits their mechanical properties and poses design constraints. An important technical requirement in P/M, therefore, is full-density consolidation.

Full-density consolidation is defined as the process of converting a powder into a fully densified and metallurgically integrated bulk material. It requires both physical densification of the powder compact and metallurgical joining of the powder particles. In any consolidation route, powder joining necessarily requires diffusional mass transport, which normally requires a high consolidation temperature. This deleteriously affects the microstructure of consolidated material. Virtually all of the high-performance materials produced by P/M routes, such as rapid solidification processing alloys and metal-matrix composites (MMC), suffer from structural degradation caused by the excessive but necessary exposure to high temperatures during consolidation.

Three fundamental approaches to full-density consolidation are identified: sintering-based consolidation, pressure-based consolidation, and shock wave consolidation. Full-density consolidation is, however, not generally achieved in sintering-based consolidation, as only weak capillary forces drive densification, while slow diffusion limits the rate. Pressure-based consolidation and shock-wave consolidation do produce fully densified materials, but often at the expense of excessive microstructural changes and increased cost.

Conventional powder consolidation methods, such as sintering, extrusion, rolling, and hot isostatic pressing, all require at least high consolidation temperatures, and for full densification, high stress as well, to produce a consolidated material with acceptable properties, such as strength, ductility, and toughness. Exposure to high consolidation temperatures deleteriously affects material microstructure. In addition, the exposure to high consolidation temperature necessitates use of a protective atmosphere or a vacuum. Furthermore, full densification normally requires a high consolidation stress. The latter two requirements make these conventional methods capital cost-intensive.

Alternatively, cold dynamic compaction, a currently available consolidation method that uses a shock wave that propagates through a powder compact, can be employed for consolidation without exposure to high temperatures. However, powder consolidation occurs only at the moment when the shock wave passes, and the energy of the shock wave attenuates as it propagates through the powder compact, thus producing non-uniform and often insufficient consolidation.

### SUMMARY OF THE INVENTION

A vibratory powder consolidation process is provided in which a powder material under a static compressive loading is subjected to ultrasonic vibratory energy, resulting in a fully dense consolidated part. Consolidation results from inter-particle rubbing that produces oxidation-free particle surfaces, local particle deformation and particle joining. The vibratory powder consolidation process produces high-performance materials at low cost with minimum structural degradation. The full-density consolidation is achieved at low to warm temperatures, preserving particle microstructures and properties, and within a short time, such as 1 second.

The process can be used with a variety of powder materials, including metallic, ceramic, semiconductor, polymeric, rapid solidification processed, and composite materials. The powders can have a wide range of particle sizes, shapes, phases, and microstructures, including nano-particles. Small parts, near-net shape parts, and parts with complex shapes can be readily produced. The resulting parts can be used in a variety of fields, including in MEMS applications.

### DESCRIPTION OF THE DRAWINGS

The invention will be more fully understood from the following detailed description taken in conjunction with the accompanying drawings in which:

FIG. 1 is a schematic illustration of one embodiment of a sonotrode assembly for use with the vibratory consolidation process of the present invention;

FIG. 2 is a micrograph of an Al compact processed by warm pressing of powder at 573 K without ultrasonic vibrations as a control;

FIG. 3 is a micrograph of an Al compact processed at 573 K with ultrasonic vibrations according to the present invention;

FIG. 4A is a micrograph of a center region of an Al compact processed at 573 K with ultrasonic vibrations for 1 s according to the present invention;

FIG. 4B is a micrograph of a side region of an Al compact process at 573 K with ultrasonic vibrations for 1 s according to the present invention; and

FIG. 5 is a micrograph of a center region of an Al compact processed at 573 K for 0.05 s according to the present invention.

### DETAILED DESCRIPTION OF THE INVENTION

A process is provided that consolidates a powder material by the application of high frequency, or ultrasonic, vibrations while maintaining the powder under static compressive loading. Vibratory or ultrasonic powder consolidation is based on material joining under high strain-rate surface rubbing and cyclic deformation. Vibratory energy is transmitted to a surface of a powder sample or compact, which may be confined in a mold or free standing, through a sonotrode or other high frequency transducer.

With vibratory powder consolidation, full-density consolidation is achieved at low to warm temperatures within a short period of time, often less than a second for thin specimens. Consolidation results from the inter-particle rubbing action caused by imposed high-frequency vibrations that produce oxidation-free particle surfaces, local particle deformation and particle joining. Consolidation initiates at the powder surface facing the sonotrode tool tip through which the vibratory energy is transmitted to the powder and propagates into the powder compact. Unlike cold dynamic compaction, the vibratory energy does not attenuate as the consolidation front propagates through the powder compact, because a constant amount of energy is transmitted to the consolidation front through the consolidated part of the material in which frictional loss is minimal. Full densification occurs as the consolidation front squeezes out the gas from the material being consolidated while deformation-enhanced diffusion facilitates interparticle joining even at low temperatures. During the vibratory compaction process, oxides or other impurities on the particle surfaces are scrubbed off. The high strain-rate deformation gives rise to a high (excess) vacancy concentration, which promotes consolidation through enhanced rates of mass transport and phase transformations.

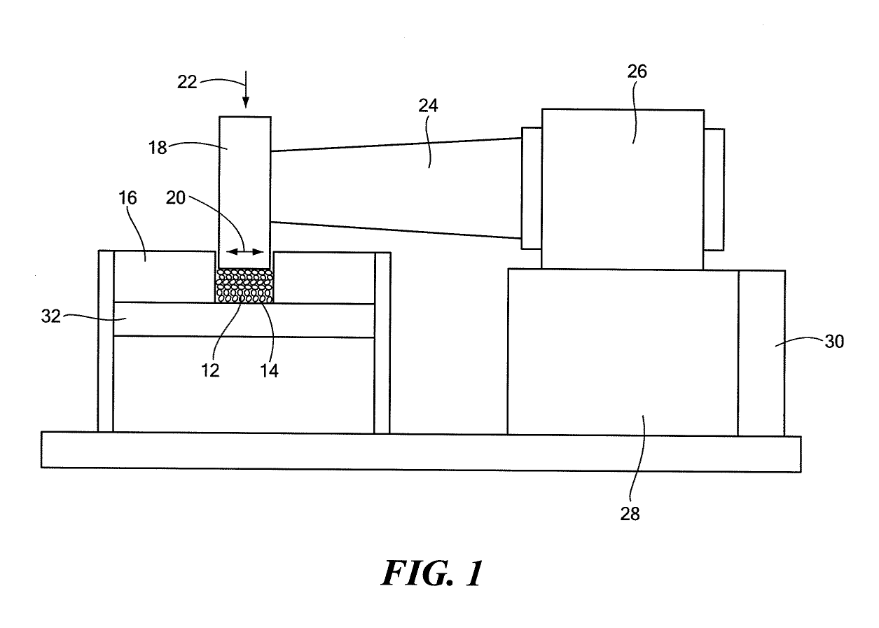

One embodiment of a sonotrode system suitable for vibratory powder consolidation is illustrated schematically in FIG. 1. A powder material or compact 12 is supported in a die or mold cavity 14 in a mold assembly 16. A sonotrode 18 in contact with a surface of the powder compact oscillates horizontally or in a direction parallel to the powder compact surface to apply ultrasonic vibrations to the powder, indicated by arrows 20. The sonotrode also applies a static pressure on the powder in the cavity normal to the powder compact surface, indicated by arrow 22. The sonotrode is coupled with an appropriate coupling 24 to a transducer and compression assembly 26 driven by appropriate drivers 28 to provide a high frequency electric energy for transformation to mechanical energy and to provide uniaxial static compression, as is known in the art.

The sonotrode frequency typically ranges from 1 to 120 kHz. The amplitude typically ranges from 1 to 100 microns, preferably 5 to 30 microns. The duration of vibrations typically ranges from 0.01 to 10 seconds, preferably about 1 second. A longer duration can be used if, for example, it is desired to work harden the material.

A suitable controller 30 is provided to control the sonotrode system to achieve the desired process parameters, such as frequency, amplitude, pressure, time, temperature. The system can include appropriate sensors, such as thermocouples, pressure transducers, and strain gauges, to measure temperature, compression, and shear stress. The sensors are in communication with the controller.

As noted above, the sonotrode exerts a constant or static uniaxial pressure normal to the direction of vibrations. The sonotrode moves downwardly during vibration to provide the constant pressure. The pressure can be measured in any suitable manner, such as by a pressure transducer beneath the mold in communication with the controller for control of the sonotrode. The pressure should be less, than the yield point of the material, but large enough to achieve sufficient friction between the powder grains and so that deformation can occur at the powder interfaces.

The sonotrode is made of, for example, tool steel, and may be carbide coated. The face of the sonotrode that contacts the powder preferably should not stick to the powder grains. The face may be covered with a non-stick material, such as a smooth metal sheet, if necessary.

The mold or die cavity 14 is supported by an anvil or other rigid supporting fixture 32 that is capable of absorbing the pressure and vibratory forces exerted on the powder. The anvil may be carbide-coated. The anvil may be formed of or may include a window formed of a transparent material such as quartz to allow temperature sensing and inspection of the powder, such as with an IR camera or pyrometer. The cavity has sufficient clearance in the direction of vibration to accommodate the maximum vibration amplitude of the sonotrode. The mold cavity can be any suitable size and shape, depending on the desired finished part. The mold cavity can be adjustable for a variety of part configurations. The cavity can be configured to form parts of simple shapes or of complex shapes and can be configured to achieve a near-net shape part.

A heating system (not shown) to heat the mold can be provided or the mold or assembly can be enclosed in a heating chamber. The powder can be consolidated at temperatures ranging from ambient or room temperature to a temperature close to the melting temperature of the material. Preferably, the powder is heated to between one-third and two-thirds of the melting point in Kelvins, or of the lowest melting point if a mixture of powders is provided. The temperature can be monitored in any suitable manner, such as with one or more thermocouples in the mold.

A cooling system (not shown) can also be provided, for example, to quench the part after consolidation. For example, a cooling fluid can be caused to flow through channels in the mold.

The sonotrode and mold cavity can be placed in a chamber (not shown) to control the process atmosphere if desired. For example, a gas such as N₂ can be introduced into the chamber to minimize oxidation or other reactions. Also, a gas can be used to allow the gas to diffuse into the material being consolidated where it may solid-solution strengthen the material or react with elements in the material to produce a useful second phase.

In another embodiment, larger parts such as sheets can be formed, for example, using a compression roller mechanism to shape the powder material into a sheet form. Vibratory energy can be applied to the sheet during or after the rolling step.

The vibratory powder consolidation process can be applied to a wide variety of powder materials and mixtures of powder materials, including metallic, ceramic, semiconductor, polymeric, and composite materials. The process can be used for powders having a wide range of particle sizes, shapes, phases, and microstructures, including nano-particles. The particles can be spherical, oblong, flakes, plates, wires, rods, or have other regular or irregular geometries. A binder material can be added to the powder if necessary to aid the powder particles in holding together prior to the vibratory consolidation step, as would be known in the art.

A variety of metals, such as, without limitation, aluminum, magnesium, and nickel metal powders and combinations of these metals, are suitable for this process. Other materials include metal-ceramic composites, such as Al—SiC, Al—Al₂O₃, and metal-matrix composites (MMC), such as magnesium matrix composites. The process can be used for semiconductor compounds, for example, of the bismuth-chalcogenide (Bi₂Te₃) family, which is useful for thermoelectric applications.

The process is applicable to rapid solidification processed (RSP) alloys. RSP powders can be prepared by a variety of methods, such as gas atomization, centrifugal atomization and melt spinning and comminution. Another process is the uniform droplet spray process, in which the quench rates can be controlled so that spherical particles having different diameters and microstructures (different grain sizes, morphologies, and phase constitutions) can be produced.

Nano powders can be added to the powder mix to enhance material performance, such as in limiting micro-cracks to increase toughness. Carbon nano-tubes can be added for purposes such as customizing electrical conductivity or thermal performance. Such materials can be used as substrates for microelectronics to cool chips or protect devices.

The process is useful for producing smaller parts, such as hard cutting instruments, tool coatings, and electronics. Small parts can include, for example, RF antennas for small devices, microfluidic channels for chemical assays, or metal MEMS casings, which can constitute a large fraction of MEMS total cost. Micro-patterned structures for MEMS applications and near-net micro-scale parts can be suitably fabricated, because of the ability of the process to fill corners in micro-scale trenches. The process can be applied to a MEMS system through the consolidation of metallic powders directly into micromolds formed by MEMS technologies, such as LIGA or other thick metal deposition processes. Powder consolidated materials can be integrated directly onto the micromold, or a free standing powder material can be consolidated after the mold has been removed, e.g., lift-off process or selective etching. This application to micromolding is advantageous, because cost effective metal etching techniques for micropatterning are not suitable for obtaining good tolerances in corners. The present process is able to fill corners and remove gases in a more cost efficient manner.

The process can be used for the consolidation of thermoplastic pellets (ABS, PVC). The thermomechanical model and the equipment can be readily modified to adapt to the consolidation of plastics and polymer-matrix composites. For example, the ultrasonic vibration direction is in compression rather than shear. The bonding mechanism in polymer processing (internal viscous friction, macromolecular entanglement, cross-polymerization, etc.) differs from that in metals.

Vibratory powder consolidation is suitable for materials such as base metal powders that have properties (magnetic, thermal, optic, and chemical) that can be maintained by processing at low temperatures. For example, ferromagnetic materials must be processed at temperatures below their Curie temperatures to maintain their magnetic properties. Such materials find uses as microbeads and other shapes for magnetic assays in reactions and in MRI-related medical devices inserted in the body. Exothermic alloys include metals that must be processed at low temperatures to create alloys that can be ignited to produce heat. Such materials can be useful as portable heat sources or can be integrated into thermal devices. Transparent metal oxides can maintain their transparency during processing at low temperatures. Such materials can be used, for example, as LCDs in projectors and in solar cells. Electrochemical materials having the potential for solid state reactions can be preserved with lower processing temperatures. These materials can be used as small-sized batteries or integrated batteries in devices.

### EXAMPLE

Compacts of Al powder were processed using several routes, as follows:
1) ultrasonic vibrations at room temperature;
2) ultrasonic vibrations at room temperature and subsequent heat treatment at 573 K;
3) ultrasonic vibrations at room temperature and subsequent impact loading at room temperature;
4) ultrasonic vibrations at room temperature and subsequent impact loading at 573 K;
5) ultrasonic vibrations at 573 K; and
6) warm pressing at 573 K (control route).

The Al powder, of 99.5% purity, ˜325 mesh, had an average particle size of 7 to 15 μm. For processing routes 1-5, ultrasonic vibrations were applied at a vibration amplitude of 10 μm and durations of 0.05 s and 1 s and normal loadings of ˜100-200 MPa, up to a maximum normal loading of 320 MPa. Processing routes 1, 2, 3, 4, and 5 resulted in fully dense compacts, whereas the control sample from route 6 remained porous.

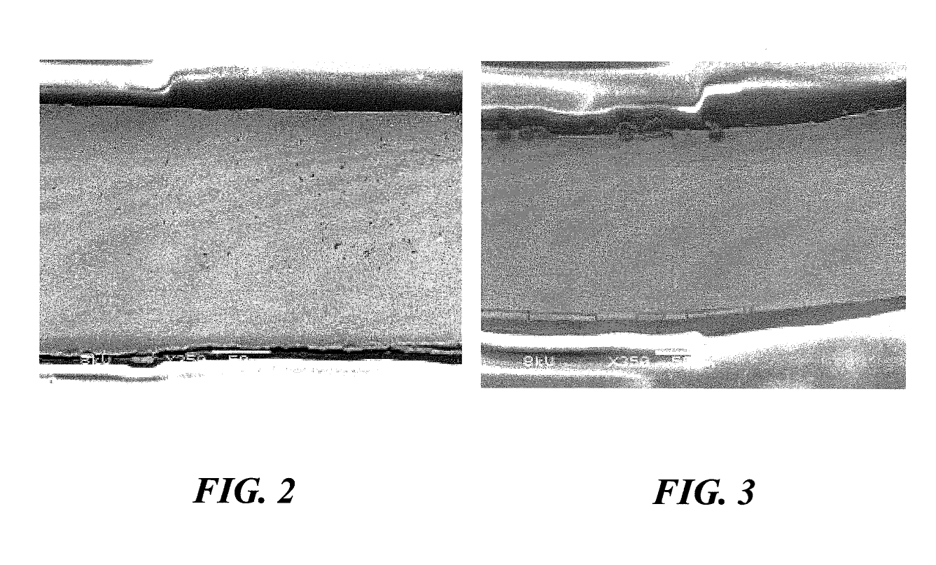

FIG. 2 shows the microstructure of a compact processed by the control route 6. FIG. 3 shows the microstructure of a compact processed by route 5. These microstructures show that the ultrasonic vibrations effected particle rearrangement and gas removal and produced full density compacts.

Processing routes 4 and 5 resulted in ductile compacts that could be bent repeatedly, indicating that surface oxides were dispersed and metallurgical bonding was achieved between the pure aluminum matrices of the particles. Processing routes 1, 2, 3, and 6 resulted in more brittle compacts.

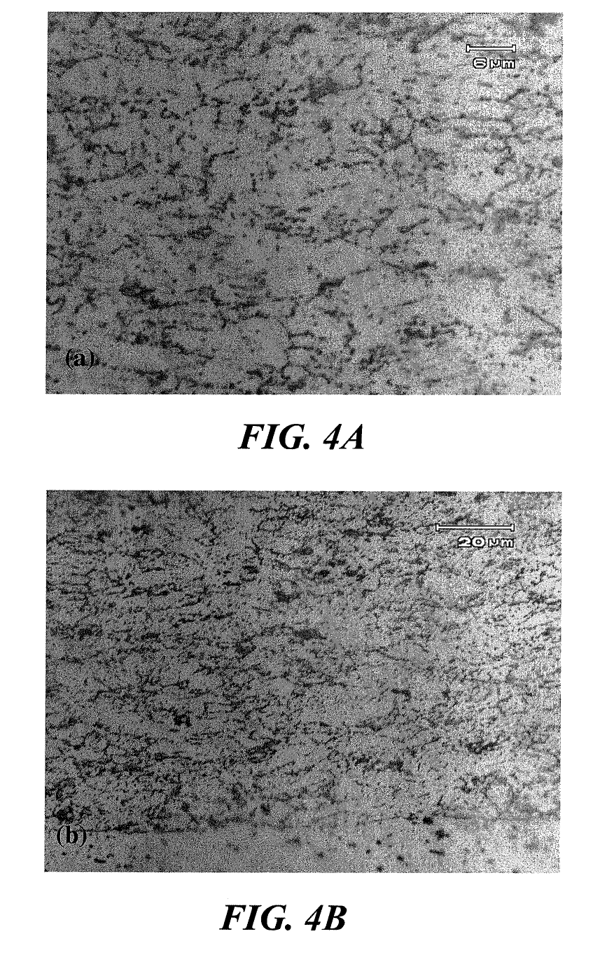

FIG. 4A illustrates the microstructure at a central region of an Al compact processed by route 5 at 1 s, and FIG. 4B shows a side region of an Al compact processed by route 5 at 1 s. Both microstructures show extensive plastic deformation.

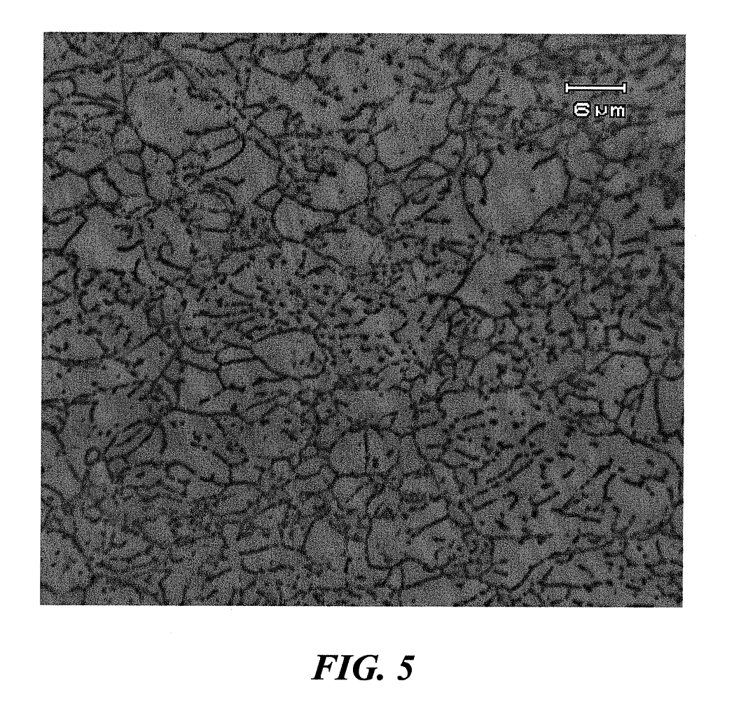

The microstructure of an Al compact produced by route 5 at 0.05 s is illustrated in FIG. 5. This microstructure shows that gas removal proceeds rapidly, although shear deformation and subsequent breaking down of surface oxides is more time dependent.

Compacts produced by routes 1 and 5 exhibited greater Vickers microhardness values than compacts produced by the control route 6.

In contrast to prior art full-density consolidation processes, the vibratory powder consolidation process of the present invention can achieve full-density consolidation, in which both full densification and metallurgical, particle joining are achieved rapidly, economically and without affecting the microstructure and properties of the starting powder. Low temperature solid state processing ensures dimensional precision and minimizes residual stress. The process uses robust, compact, low cost, low power equipment. The process can achieve high productivity, is energy efficient and clean, and eliminates health and safety hazards. Because the process does not require cooling or atmospheric protection, it is more environmentally protective.

The ability to consolidate powder at low temperatures within a fraction of a second relaxes the constraints of atmospheric control for most metallic materials, including aluminum and magnesium alloys that are among the most oxidation-susceptible materials, leading to reduced equipment costs. The short duration and low consolidation temperatures also permit the consolidation of powders with novel microstructures, such as rapid solidification microstructures, into bulk materials having virtually the same original novel microstructures.

The capital costs of the vibratory powder consolidation equipment are lower than that of conventional consolidation technology, allowing more experimentation and innovation with P/M materials. The process allows industrial problems and needs to be solved through engineered materials, which take advantage of powder properties and composites, and near-net shape manufacturing, such as for MEMS devices. Development can progress of a new class of materials with non-conventional powders, such as RSP and composite powders, that require cold/warm consolidation for their highest performance. The process can be applied to the consolidation of nano-powders with little or no undesirable structural changes.

The invention is not to be limited by what has been particularly shown and described, except as indicated by the appended claims.

What is claimed is:

1. A vibratory powder consolidation process comprising:
providing a compact of a powder material;
subjecting the powder material to a static compressive loading;
subjecting the powder material to vibratory energy while under the static compressive loading.

2. The process of claim 1, wherein the vibrations are applied in a direction normal to the direction of the compressive loading.

3. The process of claim 1, wherein the vibrations are applied in a direction parallel to a surface of the powder material compact.

4. The process of claim 1, wherein the vibrations are applied in a direction parallel to the direction of the compressive loading.

5. The process of claim 1, wherein the vibrations are applied by a sonotrode system.

6. The process of claim 1, wherein the vibrations are applied for a duration of 0.01 to 10 seconds.

7. The process of claim 1, wherein the vibrations are applied at a frequency of 20 to 120 kHz.

8. The process of claim 1, wherein the vibrations are applied a an amplitude of 1 to 100 microns.

9. The process of claim 1, wherein the compressive loading is less than a yield point of the powder material and large enough to achieve sufficient friction between grains so that deformation can occur at grain interfaces.

10. The process of claim 1, wherein the compressive loading is applied uniaxially normal to a surface of the powder material compact.

11. The process of claim 1, wherein the compact is heated to a temperature between ambient temperature and a melting temperature of the powder material.

12. The process of claim 1, wherein the compact is heated to a temperature between one-third and two-thirds of a melting point in Kelvins of the powder material.

13. The process of claim 1, wherein the compact is quenched after the compact has been subjected to the vibrations.

14. The process of claim 1, wherein the compact is supported in a mold cavity.

15. The process of claim, 1, wherein the mold cavity is configured to provide a near-net shape part.

16. The process of claim 1, wherein the compact is free standing.

17. The process of claim 1, wherein the compact comprises a sheet.

18. The process of claim 1, wherein the compact is subjected to the vibrations in a controlled atmosphere chamber.

19. The process of claim 1, wherein the powder material comprises a metal, a combination of metals, a metal-ceramic composite, a metal-matrix composite, or a semiconductor compound.

20. The process of claim 1, wherein the powder material comprises aluminum, nickel, magnesium, or mixtures of aluminum, nickel, or magnesium.

21. The process of claim 1, wherein the powder material comprises a material formed by a rapid solidification process.

22. The process of claim 1, wherein the powder material comprises nano-particles.

23. The process of claim 1, wherein the powder material comprises a plastic, thermoplastic, polymer, or polymer-matrix composite material.
